(19) United States
(12) Patent Application Publication
(10) Pub. No.: US 2016/0113232 A1
(43) Pub. Date: Apr. 28, 2016

(54) ANIMAL CAGE BEDDING AND WASTE DISPOSAL SYSTEM

(71) Applicants: Frank Thompson, Longwood, FL (US); Toni Merlington, Orlando, FL (US)

(72) Inventors: Frank Thompson, Longwood, FL (US); Toni Merlington, Orlando, FL (US)

(21) Appl. No.: 14/525,275

(22) Filed: Oct. 28, 2014

(51) Int. Cl. A01K 1/015; A01K 1/01

(52) U.S. Cl. CPC A01K 1/0155; A01K 1/01

(57) ABSTRACT

A bedding and waste disposal system for use with a pet cage tray includes a nonporous outer liner that transitions between an open shape and a closed shape, a retention member having a bottom wall and a plurality of side walls is positioned within the liner, and pet bedding is positioned along the bottom wall of the retention member.

### TECHNICAL FIELD

The present invention relates generally to pet bedding, and more particularly to an all-in-one pet bedding and disposal system for pet cages.

### BACKGROUND

The statements in this section merely provide background information related to the present disclosure and may not constitute prior art.

Pet bedding products for small animals such as hamsters, guinea pigs and rabbits, for example, typically consists of loose wood pulp, cedar, or pine shavings, and/or other additives that are designed to absorb pet excrement. In this regard, pet bedding is traditionally placed directly onto the tray of the pet cage in which the animal is housed.

Over time, the loose pet bedding becomes dirty owing to the constant exposure to pet excrement as well as spilled food and water. As such, every couple of weeks, the pet owner must dedicate a substantial amount of time and effort to remove the soiled bedding, and to rinse and dry the cage itself, as the soiled bedding typically rests directly on the cage tray. Once the cage has been thoroughly cleaned and dried, additional pet bedding is installed, and the process is repeated again.

In light of the above, it would be beneficial to provide an all-in-one animal cage bedding and waste disposal system that can protect the cage tray from making contact with soiled pet bedding, and that can be installed and removed quickly and easily without suffering from the drawbacks of the above noted devices.

### SUMMARY OF THE INVENTION

The present invention is directed to a bedding and waste disposal system for use within a pet cage tray.

One embodiment of the present invention can include a nonporous outer liner that has a complementary shape to the pet cage tray. A form retention member can be positioned within the outer liner and can house pet bedding. When the bedding becomes soiled, drawstrings within the liner can be pulled, and the liner can form a bag for sealing and containing the soiled pet bedding and the form member.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of an animal cage bedding and waste disposal system that is useful for understanding the inventive concepts disclosed herein.

FIG. 2A is a top view of the nonporous liner of the animal cage bedding and waste disposal system, in accordance with one embodiment of the invention.

FIG. 2B is a perspective view of the nonporous liner of the animal cage bedding and waste disposal system in operation, in accordance with one embodiment of the invention.

FIG. 3A is a perspective view of the form retention member of the animal cage bedding and waste disposal system, in accordance with one embodiment of the invention.

FIG. 3B is a perspective view of the form retention member of the animal cage bedding and waste disposal system in operation, in accordance with one embodiment of the invention.

FIG. 4 is a perspective view of the animal cage bedding and waste disposal system in operation, in accordance with one embodiment of the invention.

FIG. 5 is another perspective view of the animal cage bedding and waste disposal system in operation, in accordance with one embodiment of the invention.

FIG. 6 is yet another perspective view of the animal cage bedding and waste disposal system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

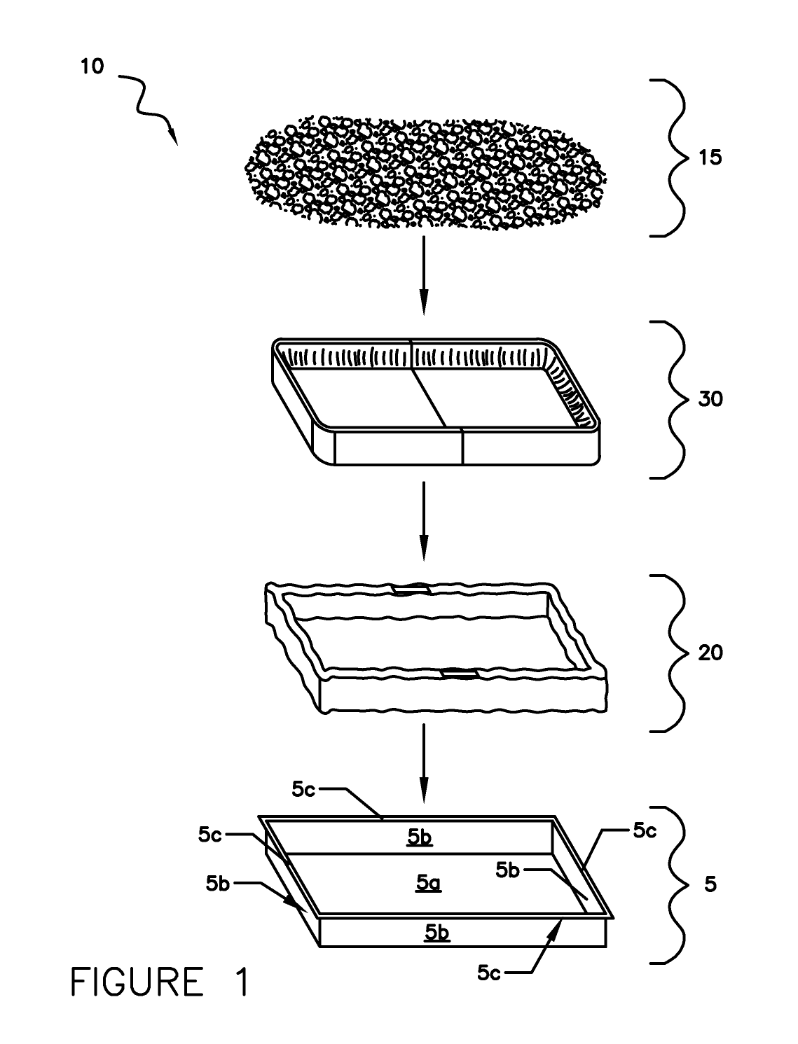

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described throughout this document, the animal cage bedding and waste disposal system 10 is designed to be used with the pet tray of any number of existing pet cages having various shapes and sizes. As such, the term “complementary shape,” “complementary dimension,” and derivatives thereof shall be used to describe a shape and size of the system that suitable for insertion within a particular pet cage having a pet tray. For example, in the instance where the pet tray includes a known/predetermined shape, such as rectangular shape, for example, the complementary shape of the system 10 can also be rectangular. Additionally, when the pet tray includes a known/predetermined dimensions of, for example, a length of approximately 20.5 inches, a width of approximately 11.5 inches and a height of approximately 3 inches, the complementary dimension of the system 10 can include dimensions of, for example, a length of approximately 20.3 inches, a width of approximately 11.3 inches, and a height of approximately 3.2 inches, for example.

Although illustrated as being used with a traditional rectangular-shaped pet tray 5 having a bottom wall 5a, a plurality of side walls 5b and an upper lip 5c that form the interior of the pet tray, this is for illustrative purposes only. In this regard, trays for pet cages are manufactured in many different shapes and sizes, therefore, the below described system can also be constructed in an unlimited number of different shapes and sizes to match the shape and size of the pet tray for which the device is intended to be used. Additionally, although described for use with a pet cage, the inventive concepts disclosed herein can be equally applied to liter boxes for cats and other such animals wherein the below described bedding can be replaced with kitty litter.

FIG. 1 illustrates an exploded parts view of an exemplary animal cage bedding and waste disposal system that is useful for understanding the inventive concepts disclosed herein. As shown, the system 10 can include a nonporous outer liner 20, a form retention member 30 and pet bedding 15 which can be installed onto a traditional shallow pet cage tray 5.

The pet bedding 15 can include any number of suitable bedding materials such as the above described loose wood pulp, cedar, or pine shavings, as well as various paper/cellulose fiber products.

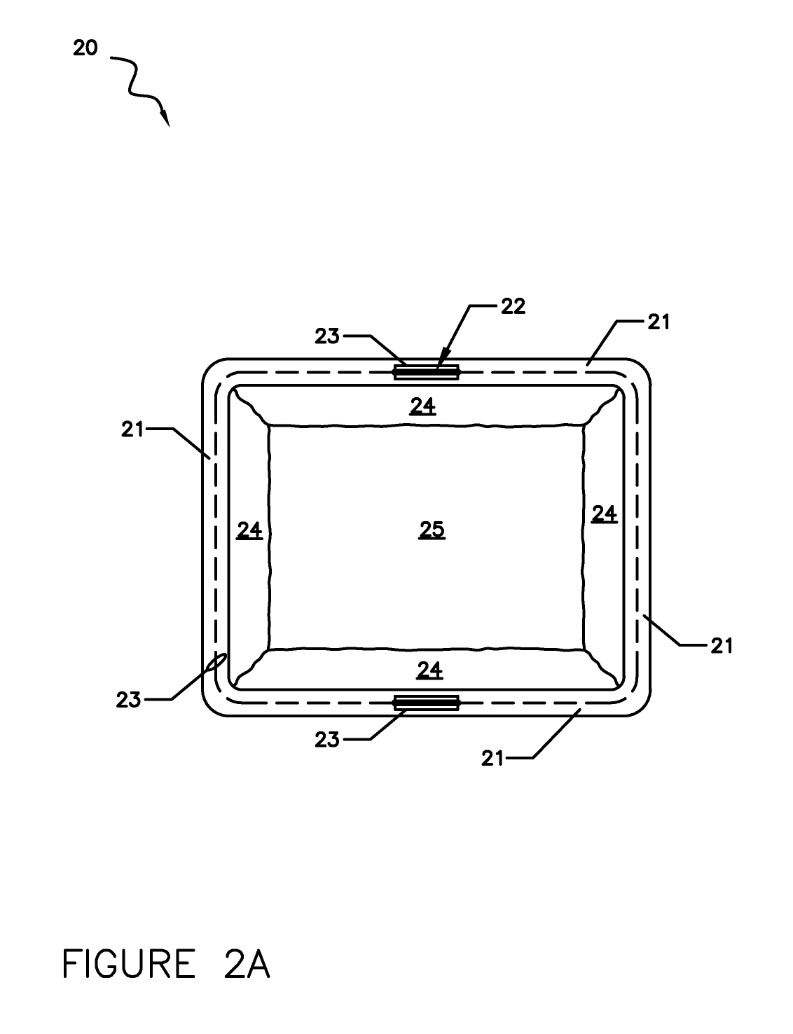

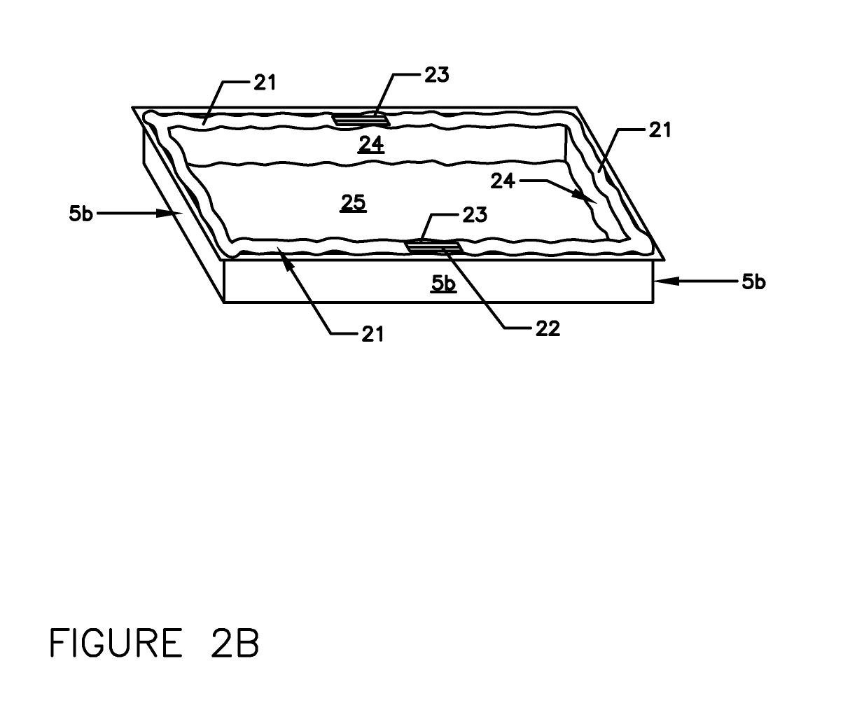

FIG. 2A illustrates one embodiment of the nonporous liner 20 for use with the system. In the preferred embodiment, the liner 20 can be constructed from polyethylene which has known elastic qualities and does not allow the passage of liquid or odors. As such, when constructed for use with a rectangularly shaped pet tray, the liner 20 can be folded to include a top lip area 21 having a drawstring 22 embedded therein and accessible via one or more openings 23. The liner can further include side walls 24 that terminate into a bottom wall 25.

FIG. 2B, illustrates one embodiment of the nonporous outer liner 20 fitted to the pet tray 5 (e.g., an open shape), wherein the remaining elements of the system 10 are removed for ease of illustration. As shown, the bottom wall 25 and side wall 24 can be inserted into the tray liner, and the top lip area 21 can be affixed about the upper rim 5c of the tray 5, wherein the elastic qualities of the liner 20, can function to prevent inadvertent separation.

Although described above as having a particular open shape and as including a polyethylene construction, this is for illustrative purposes only, as any number of other shapes and waterproof materials capable of conforming to the shape of a pet tray can also be utilized herein. For example, the liner can include a gusseted bag, for example as well as other open shapes such as a square, oval and circular, for example. Further, it is also noted that in various embodiments, the drawstring can be omitted, and the system can include a cable tie for securing the liner in the closed position.

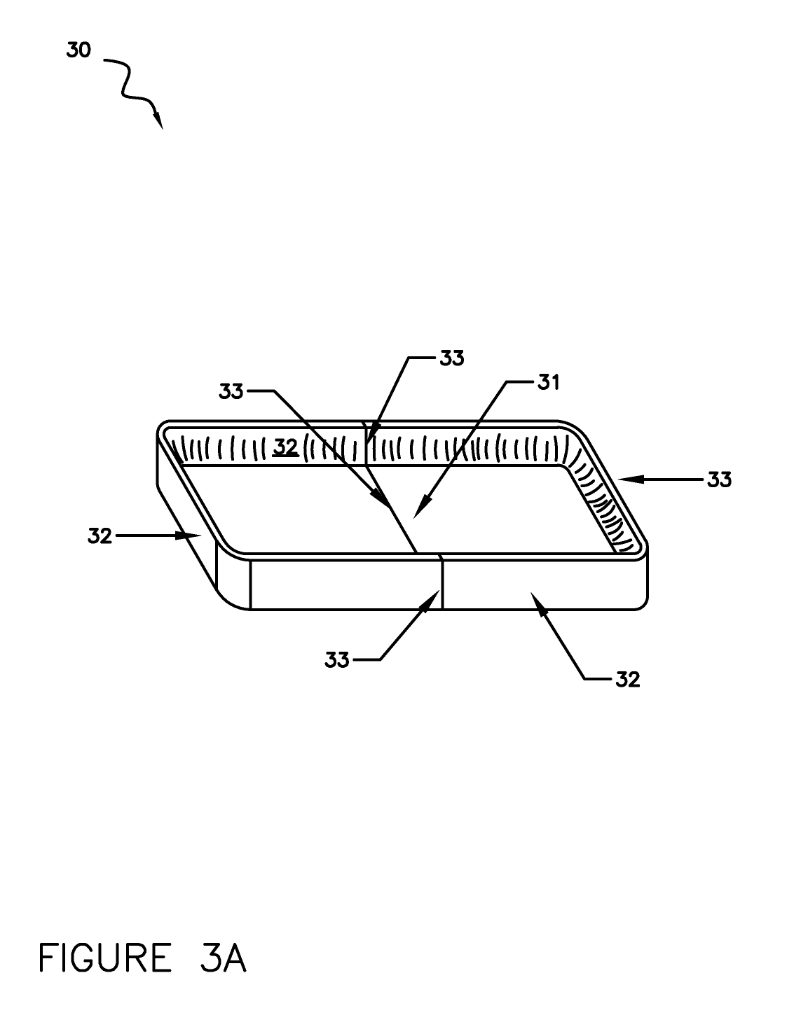

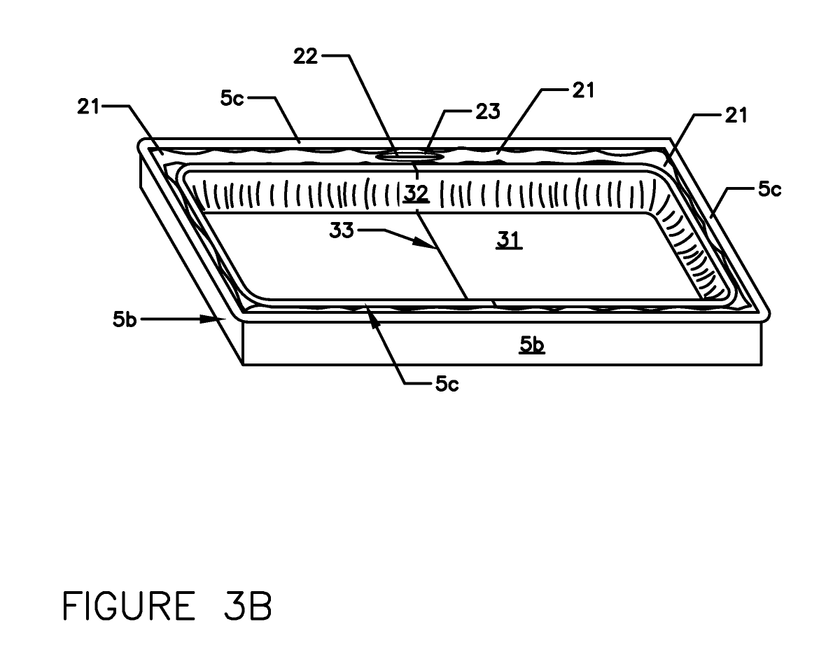

Moreover, although described above as preferably being fitted over the upper rim 5c of the tray 5, other configurations are also contemplated. In this regard, several pet trays are designed to have the upper rim 5c slide into special grooves on the cage (not illustrated). As such, the system 10 can utilize the below described form retention member 30 to maintain the shape of the liner 20, without requiring the liner to actually cover the rim (See FIG. 3B).

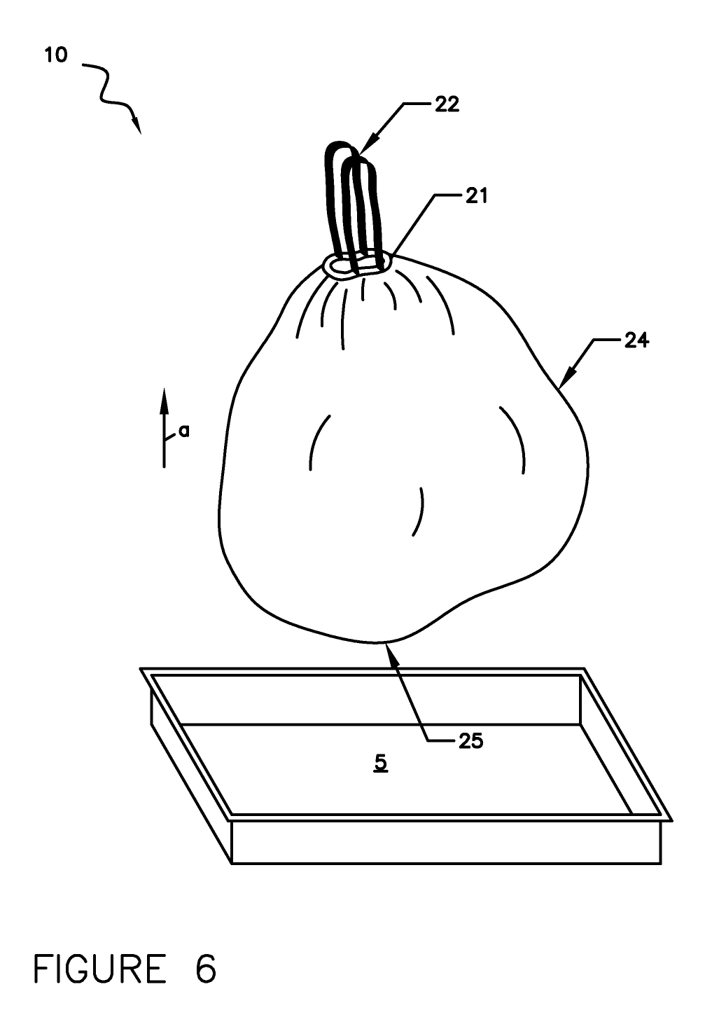

FIG. 3A illustrates one embodiment of the form/bedding retention member 30 for use with the system. In the preferred embodiment, the retention member 30 can be constructed from an organic material such as pressed paper, for example, which is safe for use with animals, as it will not cause harm to the animal if ingested. As shown, the retention member 30 can include a generally rectangular construction having a bottom wall 31 that is bounded by a plurality of side walls 32, forming a space for receiving the pet bedding 15. As the member 30 is designed to easily fold, the member can include one or more pre-scored fold lines, such as the central fold line 33 that is disposed along the center portion of the bottom wall and two of the side walls. Such a feature can function to fold the retention member 30 in half so as to make it easier for the liner 20 to capture the soiled bedding, as will be described below (See FIG. 6).

FIG. 3B, illustrates one embodiment of the retention member 30 positioned within the above described nonporous liner 20 and fitted to the pet tray 5. As shown, the bottom wall 31 and side walls 32 can be located adjacent to the bottom wall 25 and side wall 24, respectively, of the liner. In this regard, the retention member 30 can serve the dual purpose of maintaining the shape of the outer liner 20 for easy insertion into the pet cage tray 5, and can also serve as a barrier that prevents an animal located within the cage from chewing on the outer liner 20.

Although described above as including a particular shape and construction material, this is for illustrative purposes only, as any number of other shapes and materials can also be utilized herein.

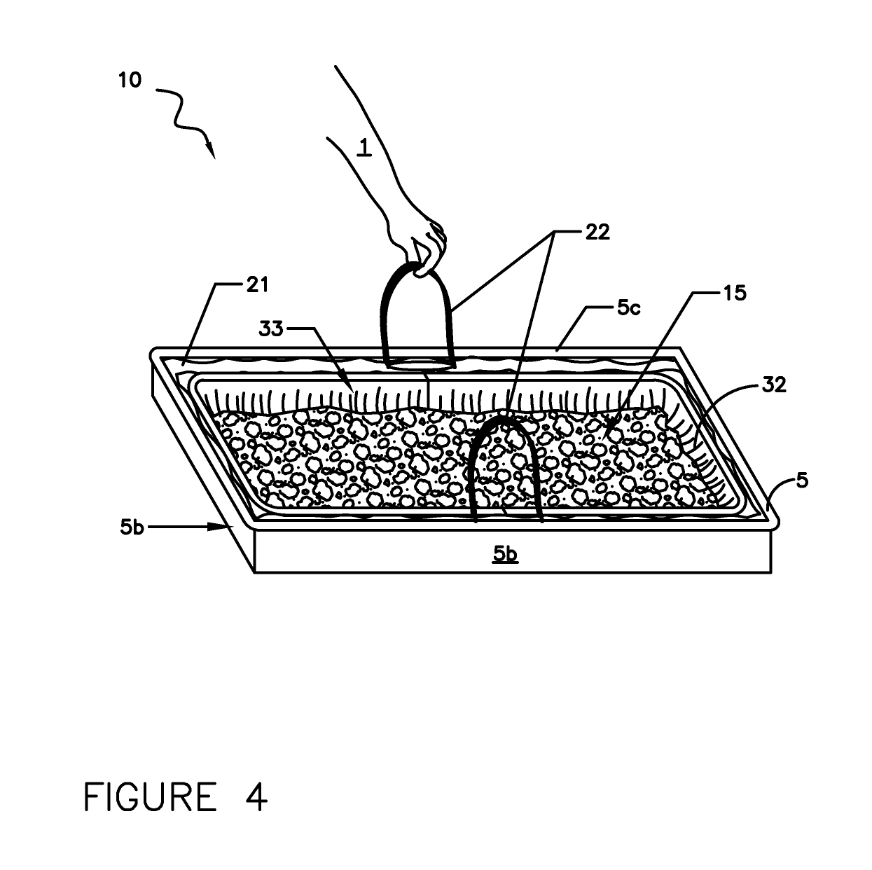

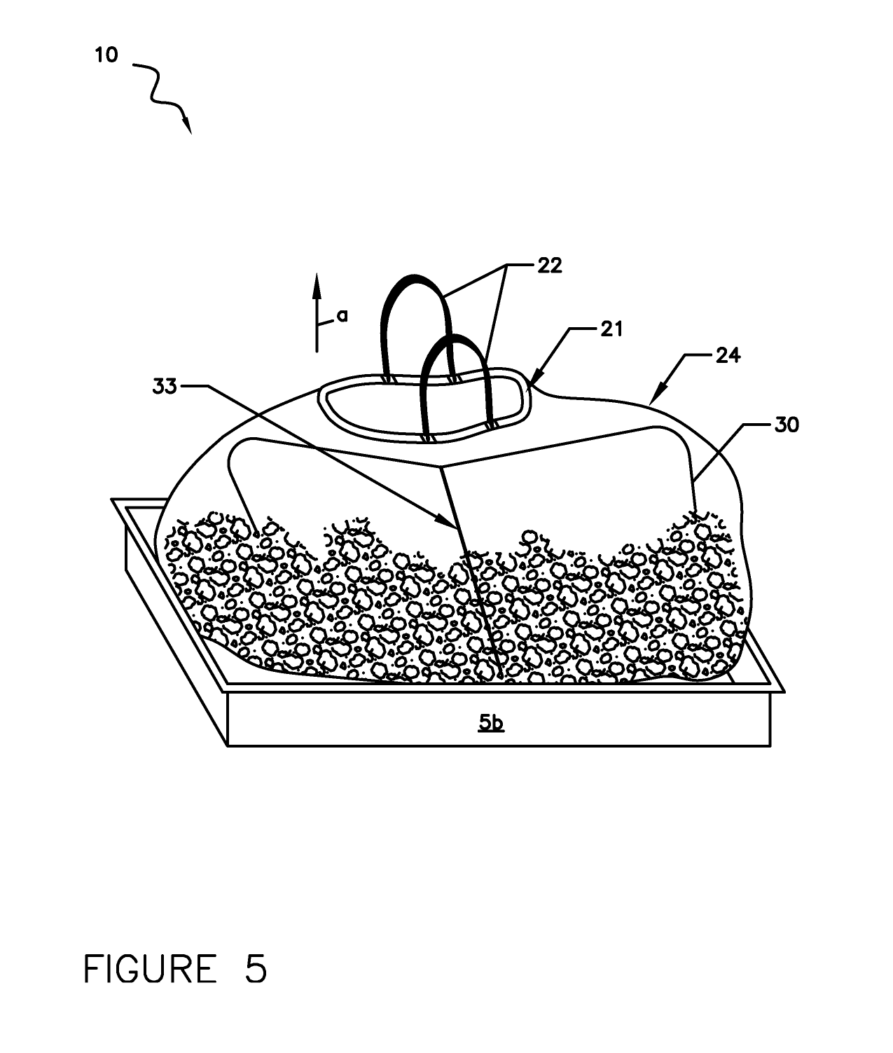

FIGS. 4-6 illustrate one embodiment of the animal cage bedding and waste disposal system 10 in operation. As shown in FIGS. 4 and 5, when the bedding material 15 becomes soiled, the user 1 can simply pull the drawstring(s) 22 of the nonporous liner upward (see arrow A). When this occurs, the top lip area 21, the side walls 24 and the bottom 25 of the liner form a bag which can completely enclose the form holder 30, the pet bedding 15 and the pet waste. During this procedure, the form member 30 can easily fold along the fold line(s) 33 in order to prevent the bedding from spilling out of the liner and making a mess.

Finally, as shown in FIG. 6, once the liner has been fully closed into a bag (e.g., a closed shape), the user can simply discard the old system, and insert a new system into the tray 5. Moreover, owing to the fact that the tray never comes in contact with the pet bedding and/or the pet waste, there is no need for the user to perform the arduous task of cleaning the pet tray.

Accordingly, the above described animal cage bedding and waste disposal system 10 provides a novel solution to traditional means of maintaining and changing pet bedding within a cage.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A bedding and waste disposal system for use with a pet cage tray, said system comprising:
a nonporous outer liner that functions to transition between an open shape and a closed shape, said liner including a complementary shape and a complimentary dimension to a predetermined shape and a predetermined dimension of the pet cage tray;
a retention member that is configured to be inserted within the nonporous outer layer, said retention member including a bottom wall and a plurality of side walls; and
pet bedding which is configured to line the bottom wall of the retention member.

2. The system of claim 1, wherein said liner includes a main body having a top lip and a drawstring that is disposed therein.

3. The system of claim 2, wherein said drawstring is accessible via one or more openings disposed along the top lip.

4. The system of claim 3, wherein the nonporous liner is configured to transition from the open shape to the closed shape when the drawstrings are pulled.

5. The system of claim 1, wherein said open shape includes a generally rectangular shape.

6. The system of claim 1, wherein said nonporous liner forms a bag when in the closed shape.

7. The system of claim 6, wherein each of the retainer and the pet bedding are sealed and contained within the liner when in the closed shape.

8. The system of claim 1, wherein the retention member is constructed from an organic material.

9. The system of claim 8, wherein the retention member is constructed from pressed paper.

10. The system of claim 1, further comprising:
at least one pre-scored line that is disposed along the retention member.

11. The system of claim 10, wherein said scored line is positioned along a center portion of the bottom wall and at least two of the side walls, and functions to fold the retention member into two even halves when the nonporous outer liner transitions to the closed shape.

12. The system of claim 1, wherein said retention member includes a complementary shape to the nonporous liner in the open shape, and is configured to maintain the nonporous liner in the open shape.

13. The system of claim 1, wherein the pet bedding is constructed from, at least one of loose wood pulp, cedar, pine shavings, paper and cellulose fiber.

14. The system of claim 1, wherein the nonporous liner is constructed from an elastomeric material.

15. The system of claim 1, wherein the nonporous liner is constructed from polyethylene.
